(19) United States
(12) Patent Application Publication
(10) Pub. No.: US 2024/0388792 A1
(43) Pub. Date: Nov. 21, 2024

(54) Motion Sensor Camera Illumination

(71) Applicant: Comcast Cable Communications, LLC, Philadelphia, PA (US)

(72) Inventors: Benny Pruden, Brownstown, PA (US); Durga Srinivasan, Downingtown, PA (US)

(21) Appl. No.: 18/319,859

(22) Filed: May 18, 2023

(51) Int. Cl. H04N 23/65; H04N 7/18; H04N 23/71; H04N 23/74

(52) U.S. Cl. CPC H04N 23/651; H04N 7/183; H04N 7/188; H04N 23/71; H04N 23/74

(57) ABSTRACT

Systems, apparatuses, and methods are described for performing individual control of multiple light emitters of a light emitting device associated with a camera. Selection of light emitters to turn on, while keeping other light emitters turned off, may be based on a motion event determined from a motion sensor and the location of the motion within a field of view or the camera. The system may conserve power by focusing the light output on the region of the motion event and relatively dimming outside of the region of the motion event.

### BACKGROUND

Security cameras may be helpful in capturing video evidence of potential crimes, and may employ motion-activated lighting to provide good quality video at night. However, many security camera systems are battery-powered, and conserving battery life will help to maximize safety.

### SUMMARY

The following summary presents a simplified summary of certain features. The summary is not an extensive overview and is not intended to identify key or critical elements.

Systems, apparatuses, and methods are described for selectively activating motion-activated lighting, via control of at least one of multiple emitters of a light device based on a direction to a motion event. A motion sensor may provide angular information of the direction pointing to the motion event from the motion sensor if the motion sensor detects the motion event in a field of view (FOV) of the motion sensor. The light device may comprise multiple emitters arranged in an array orienting at different angles to each other to provide an aggregate light output corresponding to the FOV of the motion sensor. The direction to the motion event may be used to determine to selectively power a subset of the emitters at various power levels. The light device may consume less power by limiting the light output to the motion event. As a result, a system with the light device may extend battery life.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example communication network.

FIG. 2 shows hardware elements of a computing device.

FIG. 3 shows an example block diagram of a system comprising a motion-activated light.

FIG. 4A shows a side-view of an example premises with a motion-activated light installed at the premises and configured to monitor, illuminate, and/or image an area.

FIG. 4B shows a close-up view of an example of the motion-activated light of FIG. 4A.

FIG. 4C shows an over-head view of an example of the area of FIG. 4A.

FIG. 5A shows an example image of the area of FIG. 4C.

FIG. 5B shows an example of various position.

FIG. 5C shows an example of various position.

FIG. 5D shows an example image of the area of FIG. 4C.

FIG. 5E shows an example image of the area of FIG. 4C.

FIG. 5F shows an example image of a subset of the area.

FIG. 5G shows an example image of a subset of the area.

FIGS. 6A-C collectively show a flow chart of an example method for using a motion-activated light.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

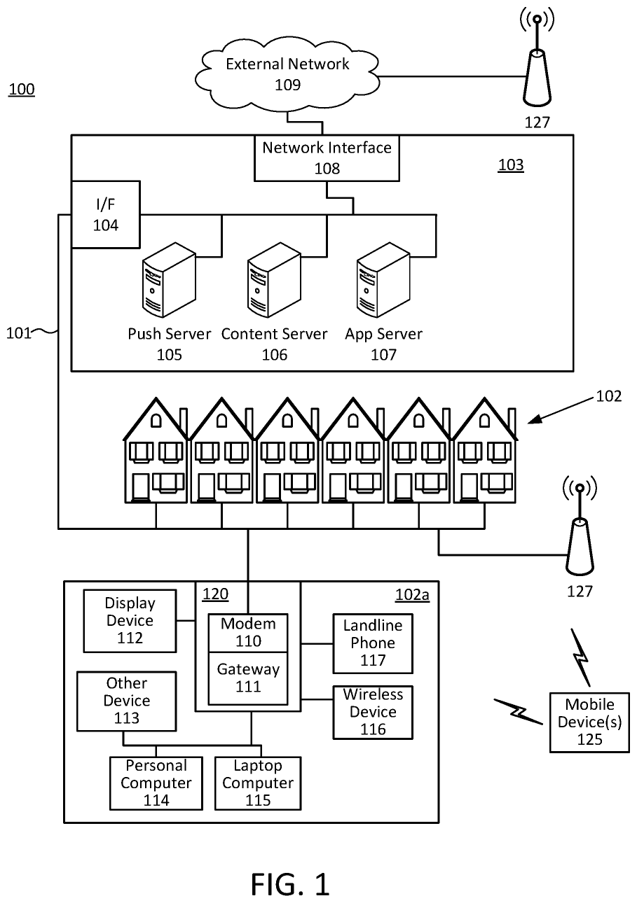

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a Wi-Fi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers communicatively coupled to other devices with wireless transceivers, and/or any other type of device configured to communicate via a wireless network.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend devices such as servers 105-107, and/or to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. The local office 103 may also or alternatively communicate with the mobile devices 125 via the interface 108 and one or more of the external networks 109, e.g., via one or more of the wireless access points 127.

The push notification server 105 may be configured to generate push notifications to deliver information to devices in the premises 102 and/or to the mobile devices 125. The content server 106 may be configured to provide content to devices in the premises 102 and/or to the mobile devices 125. This content may comprise, for example, video, audio, text, web pages, images, files, etc. The content server 106 (or, alternatively, an authentication server) may comprise software to validate user identities and entitlements, to locate and retrieve requested content, and/or to initiate delivery (e.g., streaming) of the content. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102 and/or to the mobile devices 125. The local office 103 may comprise additional servers, additional push, content, and/or application servers, and/or other types of servers. Although shown separately, the push server 105, the content server 106, the application server 107, and/or other server(s) may be combined. The servers 105, 106, 107, and/or other servers, may be computing devices and may comprise memory storing data and also storing computer executable instructions that, when executed by one or more processors, cause the server(s) to perform steps described herein.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

The gateway 111 may also comprise one or more local network interfaces to communicate, via one or more local networks, with devices in the premises 102a. Such devices may comprise, e.g., display devices 112 (e.g., televisions), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone—DECT phones), mobile phones, mobile televisions, personal digital assistants (PDA)), landline phones 117 (e.g., Voice over Internet Protocol-VoIP phones), and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on-or off-premises.

The mobile devices 125, one or more of the devices in the premises 102a, and/or other devices may receive, store, output, and/or otherwise use assets. An asset may comprise a video, a game, one or more images, software, audio, text, webpage(s), and/or other content.

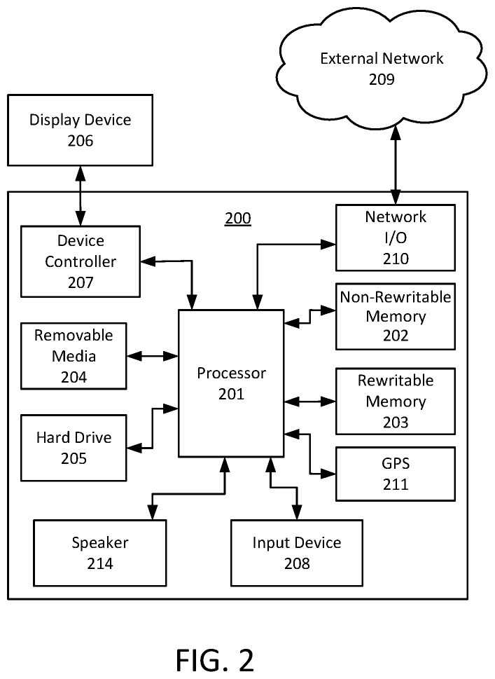

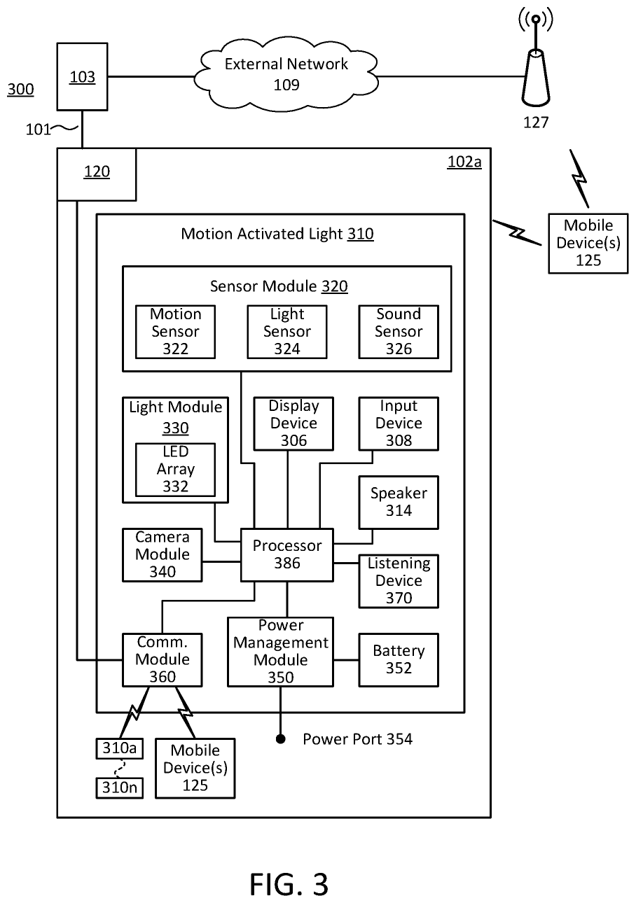

FIG. 2 shows hardware elements of a computing device 200 that may be used to implement any of the computing devices shown in FIG. 1 (e.g., the mobile devices 125, any of the devices shown in the premises 102a, any of the devices shown in the local office 103, any of the wireless access points 127, any devices with the external network 109) and any other computing devices discussed herein (e.g., a motion-activated light 310 shown in FIG. 3). The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media. The computing device 200 may comprise one or more output devices, such as a display device 206 (e.g., an external television and/or other external or internal display device) and a speaker 214, and may comprise one or more output device controllers 207, such as a video processor or a controller for an infra-red or BLUETOOTH transceiver. One or more user input devices 208 may comprise a remote control, a keyboard, a mouse, a touch screen (which may be integrated with the display device 206), microphone, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

FIG. 3 shows an example block diagram of a system 300 of a premises 102a comprising a motion-activated light 310. The system 300 may comprise the motion-activated light 310 in the premises 102a. The system 300 may comprise an interface 120. The motion-activated light 310 may be coupled to the interface 120 capable of communicating one or more other devices associated with the premises 102a and/or outside of the premises 102a (e.g., with a local office 103, with an external network 109, with a wireless access points 127, with a mobile device 125(s), etc.), as discussed above.

The motion-activated light 310 may comprise a sensor module 320, a light module 330, a camera module 340, a power management module 350, a battery 352, a power port 354, a listening device 370 (e.g., microphone), a speaker 314, an input device 308, a display device 306, and/or one or more processors 386.

The sensor module 320 may comprise a various type of sensors such as a motion sensor 322, a light sensor 324, a sound sensor 326, and/or temperature sensor (not shown). The motion sensor 322 may be configured to detect a motion event in a field of view (FOV) of the motion sensor 322 and calculate/determine a direction and/or a distance to the motion event from the motion sensor 322 (e.g., a radar with multiple receive antennas, a set of multiple passive infrared (PIR) sensors, etc.). The motion sensor may provide data indicating the direction and/or the distance to the motion event to the processor 386.

The light sensor 324 may be arranged to sense brightness of ambient light. The measured ambient brightness may be used to determine whether the ambient light is darker than a threshold brightness or not (e.g., if it is daytime and no illumination is needed). The sound sensor 326 may comprise a microphone configured to capture sound and/or determine a direction and/or a distance to a sound source. The captured sound may be used to recognize sound patterns (e.g., baby crying, emergency request, etc.).

The light module 330 may comprise multiple emitters arranged in an array, such as a light-emitting diode (LED) array 332 (e.g., may be a LED, an organic LED, a quantum dot LED, a laser diode, etc.). The LEDs may have a directional emission distribution. Each LED of the LED array 332 may be oriented at a different angle to each other to provide an aggregate light output. The LED array 332 may be placed close (e.g., co-located) to the motion sensor 322 and/or the sound sensor 326. The LED array 332 may have the same viewing perspective with the motion sensor 322 and/or the sound sensor 326. The light output of the LED array 332 may correspond to the FOV of the motion sensor 322 and/or a hearing range of the sound sensor 326. The LED array 332 may have a set of coordinates associated with the orientation angles of the LEDs, such that each LED may correspond to a coordinate position in an image (or angle of view) captured by the camera module 340. Each LED of the LED array 332 may be individually controlled to modulate a light intensity. The LED array 332 may have a variety of colors spectral range from ultraviolet (UV) to infrared (IR). The LED array 332 may comprise IR LEDs to provide good quality video at night.

The camera module 340 may comprise an image sensor to capture one or more images. The image sensor may be a CCD (charge-coupled device), a CMOS (complementary metal-oxide semiconductor), and/or any other type of semiconductor image device. The image sensor may couple to a wide-angle lens with an angle of view which may be up to 180 degrees or more. The camera module 340 may be placed close to the LED array 332 (e.g., co-located). The camera module 340 may have the same viewing perspective with the LED array 332. The angle of view of the camera module 340 may correspond to the illumination ranges of the LED array 332. The captured one or more images may be used to monitor for reflection intensity of the light from at least one LED of the LED array 332 and/or determine the location of reflection sources (e.g., unwanted glare or bright spots) in the angle of view of the camera module 340.

The camera module 340 may capture one or more images before and/or after the LED array 332 is controlled to illuminate a motion event detected by the motion sensor 322. The captured one or more images in which motion has been detected may be used to determine a region of interest (ROI) by image processing (e.g., face recognition, motion detection, etc.) and/or calculate a direction to the ROI from the camera module 340. The direction to the ROI may be used to reduce a number of LEDs of the LED array 332 that will be used in illumination, to further focus the light on the ROI, and further images may be captured by the camera module 340. The focusing of the light may comprise targeting the ROI with illumination, and reducing and/or removing illumination from other areas that may otherwise be covered by the light from the LED array 332. The determined ROI in the captured one or more images may be down-sampled and/or further processed without image data outside of the determined ROI. This may reduce the required image data processing power of the processor 386. In order to further reduce the image data processing power, one or more operation parameter of the camera module 340 may be adjusted such as capturing image data at reduced frame rates and/or binning the pixels of the image sensor to combine data from the nearby pixels into one.

The battery 352 may power the motion-activated light 310. The motion-activated light 310 may be configured to measure the battery power of the battery 352 via the power management module 350. The battery 352 may be a rechargeable battery. The power port 354 may be configured to receive an alternating current (AC) or a direct current (DC) to provide power for the motion-activated light 310 and/or recharge the battery 352. For example, the battery 352 may be recharged by a solar panel (not shown) installed at the premises 102a of FIG. 3A.

The communication module 360 may be configured to communicate with other motion-activated lights 310a-310n and/or mobile device(s) 125 via wired and/or wireless transmission. The other motion-activated lights 310a-310n may comprise the same elements as the motion-activated light 310. If desired, some of the other motion-activated lights 310a-310n may comprise different elements. One motion-activated light 310 may send, via its communication module 360, control signals to the communication modules 360 of the other motion-activated lights 310a-310n to control the other motion-activated lights 310a-310n. After the motion-activated light 310 detects a motion event, the motion-activated light 310 may turn on the LED array 332 of the one or more other motion-activated lights 310a-310n and/or capture one or more images using the camera module 340 of the one or more other motion-activated lights 310a-310n. For example, the motion-activated light 310a may be installed in a backyard, while the motion-activated light 310b may be installed on a side of a front door. If the motion-activated light 310a detects a burglar moving in the backyard, the motion-activated light 310a may send a signal to the motion-activated light 310b to activate the motion-activated light 310b, and the motion-activated light 310b may turn on one or more LEDs of the LED array 332 of the motion-activated light 310b and/or capture one or more images using the camera module 340 of the motion-activated light 310b. The motion-activated light 310 may share information to the one or more other motion-activated lights 310a-310n and/or the mobile devices 125. The information from input devices (e.g., the listening device 370, the input device 308, etc.) and/or to output devices (e.g., the speaker 314, the display device 306, etc.) of the motion-activated light 310 may be propagated to the one or more other motion-activated lights 310a-310n and/or the mobile devices 125 to be inputted and/or outputted.

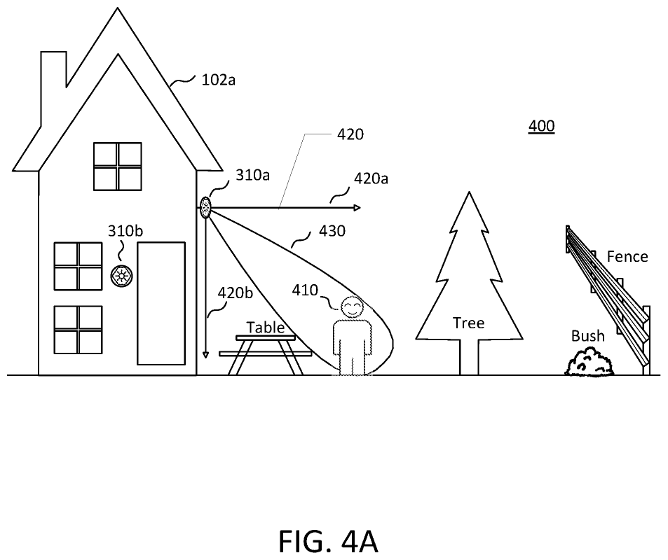

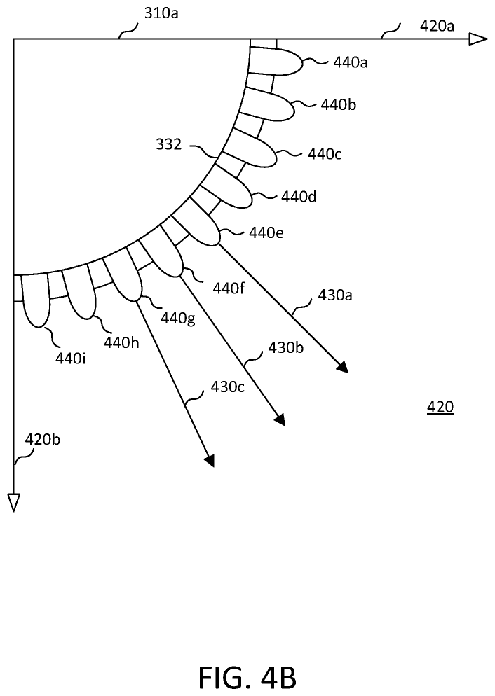

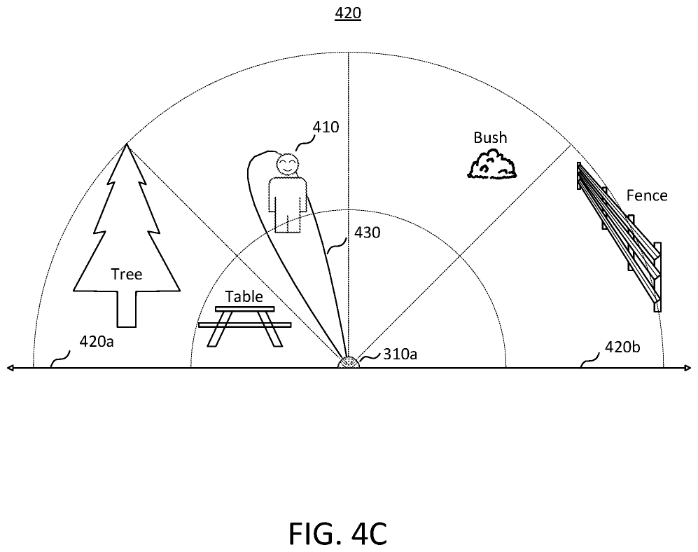

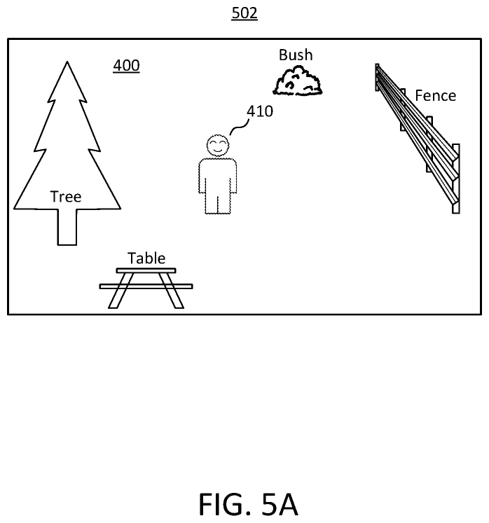

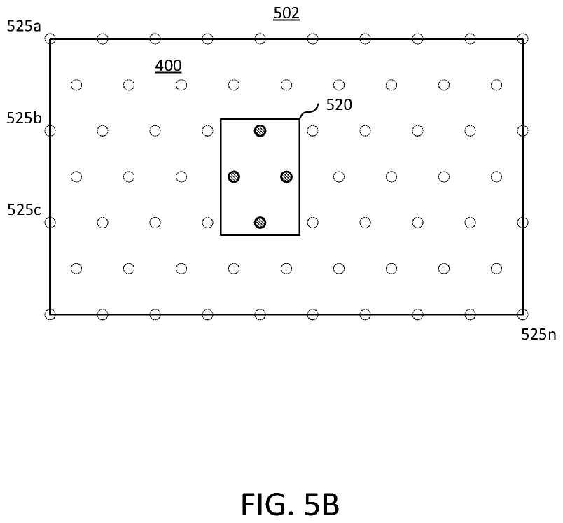

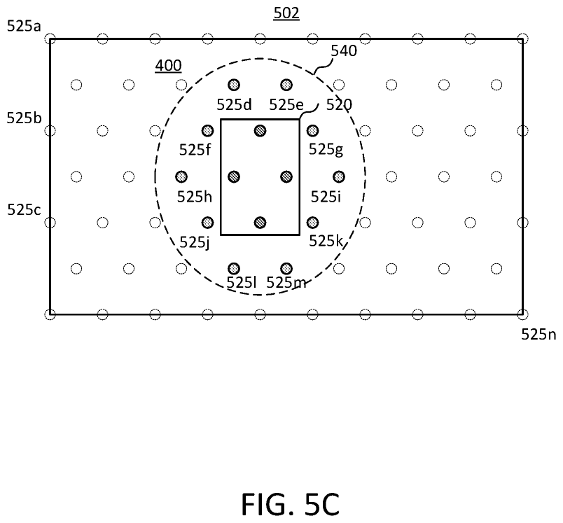

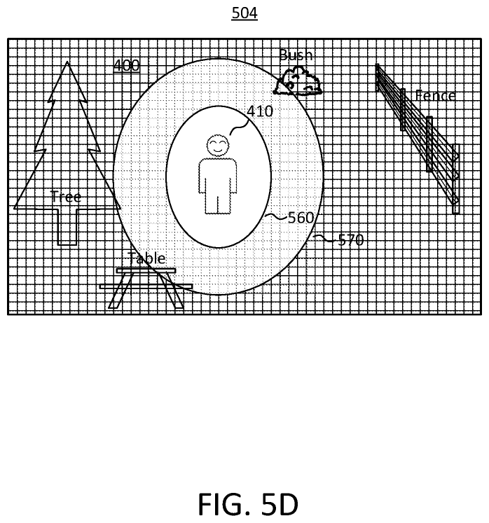

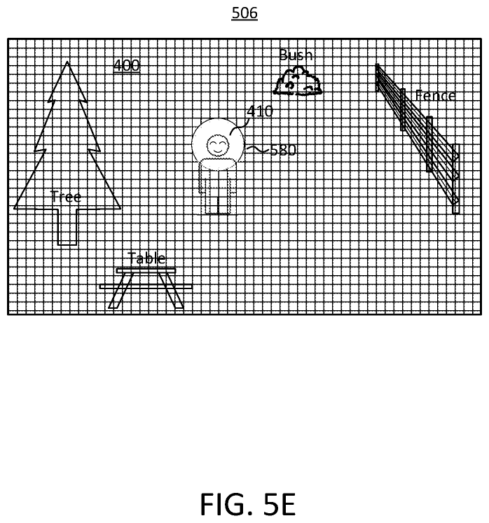

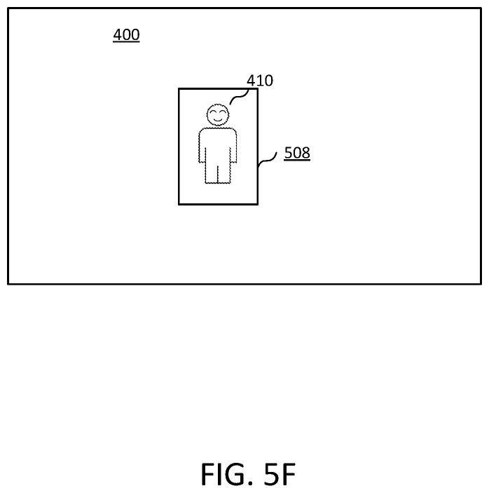

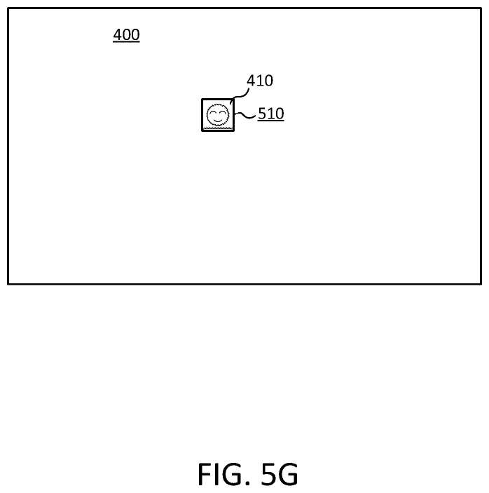

The processor 386 may be configured to receive data from the motion sensor 322 if the motion sensor 322 detects a motion event in the FOV of the motion sensor 322. The data from the motion sensor 322 may comprise a direction and/or a distance to the motion event from the motion sensor 322. The processor 386 may control at least one of multiple emitters of the light module 330 individually based on the direction and/or the distance to the motion event from the motion sensor 322. The light emitters of the light module 330 may be the LED array 332. The LED array 332 may have a color spectrum in IR range. The at least one LED of the LED array 332 may be turned on at various power levels to focus the light output on the motion event and relatively dim the outside of the motion event. Alternatively, the processor 386 may turn on the at least one LED of the LED array 332 aligned to the direction to the motion event. This will be discussed in detail with respect to FIGS. 4 and 5. The processor 386 may turn on the at least one LED of the LED array 332 at a relatively higher power level for the relatively longer distance to the motion event and at a relatively lower power level for the relatively shorter distance to the motion event. For example, it may be required to increase the light intensity of the LED array 332 to clearly visualize an object located far away from the LED array 332. As the object is getting close to the LED array 332, it may be possible to reduce the light intensity of the LED array 332. Utilizing this method, the motion-activated light 310 may consume less power than by illuminating the whole angle of view of the camera module 340 with a fixed light intensity.

In addition, the processor 386 may use additional information for controlling the LED array 332. The processor 386 may be configured to obtain ambient brightness using the light sensor 324. The processor 386 may control the at least one of multiple emitters according to the ambient brightness. For example, the processor 386 may store information indicating an ambient light threshold, beyond which the LED array 332 will not be illuminated. For example, in the afternoon, it might not be necessary to illuminate the LED array 332 for the camera module 340 to capture good quality images of a potential intruder. The processor 386 might activate the light module 330 only if the ambient light is darker than the ambient light threshold. Otherwise, the processor 386 may put the light module 330 in a default condition (e.g., turn off all the emitters, turn on the at least one of multiple emitters at a lower power level, etc.). The processor 386 may be configured to obtain sound data comprising a direction and/or a distance to a sound source from the sound sensor 326. The processor 386 may control the at least one of multiple emitters based on the direction and/or the distance to the sound source and/or perform sound pattern recognitions (e.g., baby crying, emergency request, etc.) using the sound data, to cause the LED array 332 to illuminate the subset of the hearing range of the sound sensor 326 containing the sound source.

The processor 386 may be configured to determine a location of light reflection sources in an angle of view of the camera module 340, and may adjust lighting to reduce unwanted glare in images captured by the camera module 340. For example, a backyard patio may contain shiny plastic furniture that brightly reflects light from the LED array 332, and that reflection may cause an unwanted glare in the images captured by the camera module 340. The processor 386 may, in a configuration mode, turn on some or all of the light emitters and obtain one or more images captured by the camera module 340. The processor 386 may determine location(s), in the captured images, that show an unwanted glare or bright spot (e.g., if brightness at the location(s) exceeds a glare threshold), or causes unwanted washing out of nearby regions in the images based on correlation between the operation of the at least one of multiple emitters (e.g., the driving power levels to the emitter, the coordinate of the driven emitter, the orientation angle of the driven emitter, etc.) and the one or more images of reflection intensity of the light from the at least one of multiple emitters. The processor 386 may consider the location of the light reflection sources when the processor 386 performs individual light controls of the light module 330 based on a motion event detected by the motion sensor 322. For example, the processor 386 may limit brightness of LEDs that correspond to the location of those reflection sources, to alleviate the light reflection and therefore improve clarity of captured images, night vision, etc.

The processor 386 may be configured to obtain status of the battery 352 from the power management module 350. The processor 386 may control at least one of multiple emitters of the light module 330 individually according to power saving settings of the light module 330 if the battery power is less than a threshold power value. The power saving setting of the light module 330 may comprise reducing a number of light emitters that will be used in illuminating a motion event, and/or reducing a power level and/or an illumination duration of the light emitters (e.g., pulsed light). The processor 386 may control at least one operating parameter of the camera module 340 according to power saving settings of the camera module 340 if the battery power is less than the threshold power value. The power saving setting of the camera module 340 may comprise reducing a frame rate for image capture, and/or capturing fewer pixels such as binning the pixels of the image sensor to combine data from the nearby pixels into one and/or limiting image capture to a subset of the angle of view of the camera module 340, instead of capturing an entirety of the angle of view of the camera module 340. The limiting may be associated with determining a region of interest (ROI) by image processing (e.g., face recognition, motion detection, etc.) using one or more images captured by the camera module 340 and down-sampling the determined ROI in the captured one or more images without image data outside of the determined ROI. The processor 386 may determine/calculate a direction to the ROI from the camera module 340 and turn on at least one of multiple emitters at various power levels to focus the light output on the ROI

FIG. 4A shows a side-view of an example premises 102a with a motion-activated light 310a installed at the premises 102a and configured to monitor, illuminate, and/or image an area 400. The area 400 may include multiple objects (e.g., a person 410, a table, a tree, a bush, a fence) at various physical locations. After the motion-activated light 310a detects a motion event in a FOV 420 (generally shown in the figures using limits 420a and 420b in the relevant view), such as one caused by the person 410 in the area 400, the motion event may be illuminated by light output 430 from the motion-activated light 310a. The maximum illumination range of the light output 430 (e.g., if all emitters are turned on) may be close to the FOV 420. An additional motion-activated light 310b may be installed at a different location from the motion-activated light 310a of the premises 102a (e.g., one may be in the backyard, while the other is on a side of a front door of the house). The additional motion-activated light 310b may be configured to illuminate and/or capture one or more images if the motion-activated light 310a detects the motion event.

FIG. 4B shows a close-up view of an example of the motion-activated light 310a of FIG. 4A. The motion-activated light 310a may comprise the LED array 332 of LEDs 440a-440i. Each of the LEDs 440a-440i may be oriented at a different angle to each other, or to a point of reference on the light. The motion-activated light 310a may determine to turn on a subset of the LEDs 440a-440i to illuminate a motion event in the FOV 420 (generally shown in the figures using limits 420a and 420b in the relevant view) based on the angle of the LEDs 440a-440i. For example, the motion-activated light 310a may determine to turn on the LEDs 440c, 440f, and 440g using the angle of the LEDs 440c, 440f, and 440g corresponding to the direction of the motion event caused by the person 410. The LEDs 440c, 440f, and 440g may emit light outputs 430a, 430b, and 430c, respectively. The light outputs 430a, 430b, and 430c may collectively illuminate the motion event caused by the person 410. The LED array 332 is an example, and the motion-activated light 310a may comprise multiple light-emitting elements other than the LED array 332.

FIG. 4C shows an over-head view of an example of the area 400 of FIG. 4A. The motion-activated light 310a may be capable of illuminating all, or just a subset, of the area 400. Based on a direction and/or a distance to the motion event caused by the person 410, the motion-activated light 310a may illuminate the motion event which is a small subset of the area 400. As the person 410 moves within the FOV 420 (generally shown in the figures using limits 420a and 420b in the relevant view), the motion-activated light 310a may change the illuminated subset of the LED array 332 determined based on the direction and/or distance to the motion event caused by the person 410. The motion-activated light 310a may determine that different LEDs may be turned on while others may be turned off, depending on the direction and/or distance of the motion event.

FIG. 5A shows an example image 502 that may be captured by the camera module 340, and in the example image 502 the person 410 may have been detected as moving. The image 502 may have been illuminated by the LED array 332, and FIG. 5B shows an example of various positions 525a-525n in the image 502 that may be illuminated by the various LEDs 440a-440i. The LEDs 440a-440i may include infrared LEDs as well as visible light LEDs, and the infrared LEDs may be used by the motion sensor 322 to detect motion. To detect that motion (e.g., the movement of the person 410), the motion sensor 322 may examine the image 502 to identify reflections of infrared light from the infrared LEDs, and may compare those reflections with infrared reflections in an earlier image (not shown). In the FIG. 5B example, the motion sensor 322 may have determined that the reflection of infrared light in a subset 520 of the positions 525a-525n in the image 502 is different from infrared reflections in the earlier image. In the FIG. 5B example, the subset 520 is shown to correspond to 4 LEDs, and those 4 LEDs may be controlled to illuminate the area of the image 502 (and corresponding portion of area 400) that contained the moving person 410.

The illumination may extend beyond just the subset 520. As shown in FIG. 5C, the subset 520 may be expanded to include additional positions that surround the subset 520. FIG. 5C shows an extend boundary 540 outside of the original subset 520 of the positions 525a-525n, and the additional LEDs that correspond to positions 525d-525m in that extended boundary 540 may also be illuminated. Those additional LEDs may, however, be illuminated at a lower power than the LEDs that illuminate the subset 520 (e.g., use 50% power). The additional LEDs corresponding to the positions 525d-525m in the extended boundary 540 may be determined to turn on at 25% of power level while the other LEDs outside of the boundary 540 may be determined to turn off (e.g., at 0% power level) in order to fade the illumination with distance away from the motion event. FIG. 5C is only one exemplary method to focus the light output of the LED array 332 on the motion event and there are other ways. For example, the additional LEDs corresponding to the positions 525d-525m in the boundary 540 may be determined to turn off (e.g., at 0% power level), if the motion-activated light 310a determines to turn on the 4 LEDs of the subset 520. The motion-activated light 310a may determine to control the LED array 332 based on the distance to the motion event from the motion-activated light 310a. For example, the power level for the 4 LEDs corresponding to the subset 520 may be decreased from 50% if the person 410 moves closer to the motion-activated light 310a, while the power level for the 4 LEDs may be increased from 50% if the person 410 moves away from the motion-activated light 310a.

FIG. 5D shows an example image 504 of the area 400 of FIG. 4C captured by the motion-activated light 310a with the LED array 332 control of FIG. 5C. The light output of the LED array 332 may be mainly focused on a zone A 560 and relatively dimmed in a zone B 570 so that the person 410 caused the motion event may be clearly visible in the captured image 504. In order to further reduce a number of light emitters that will be used in illumination, the captured image 504 with the LED array 332 control of FIG. 5C may be used in the face recognition image process. The motion-activated light 310a may control at least one LED of LED array 332 individually based on the results of the image processing. FIG. 5E shows an example image 506 of the area 400 of FIG. 4C captured by the motion-activated light 310a with the LED array 332 control based on the face recognition image process. The light output of the LED array 332 may be focused on a zone C 580 so that the face of the person 410 may be clearly visible in the captured image 506.

The motion-activated light 310a may be controlled to capture an image of only a partial of the FOV 420, such that the captured image may focus on the motion event. Capturing such a reduced image may further conserve power. As shown in FIG. 5D and 5E, the light output of the LED array 332 may be focused on a subset of the area 400 (e.g., the zone A 560 and the zone B 570 of FIG. 5D and the zone C 580 of the FIG. 5E). The rest of the area 400 may be in the dark and the objects (e.g., the table, the tree, the bush, and the fence) may be invisible. FIG. 5F shows an example image 508 of a subset of the area 400 captured by the motion-activated light 310a with the controlled illumination of FIG. 5D. FIG. 5G shows an example image 510 of a subset of the area 400 captured by the motion-activated light 310a with the controlled illumination of FIG. 5E. The image 508 and the image 510 may require reduced image data processing power without image data outside of the controlled illumination.

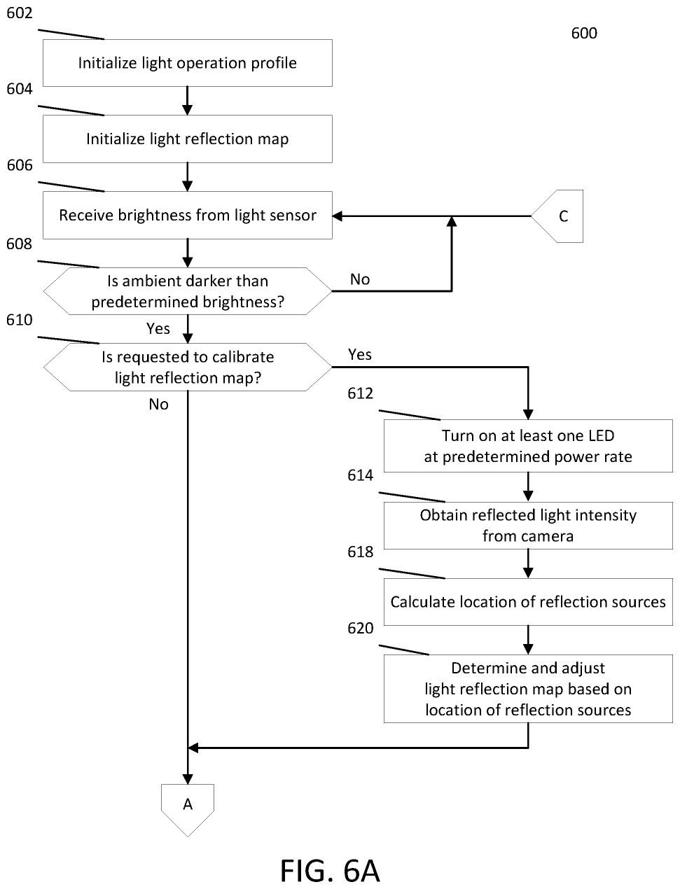

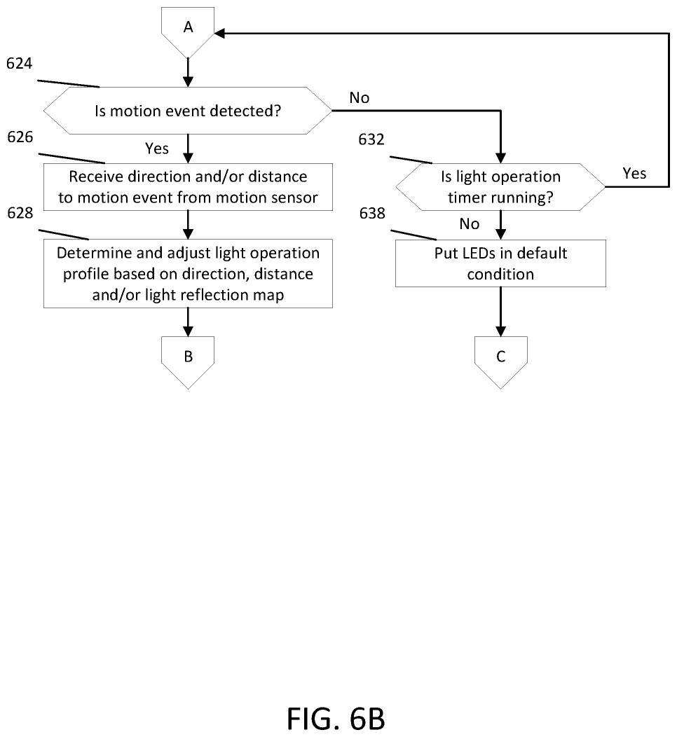

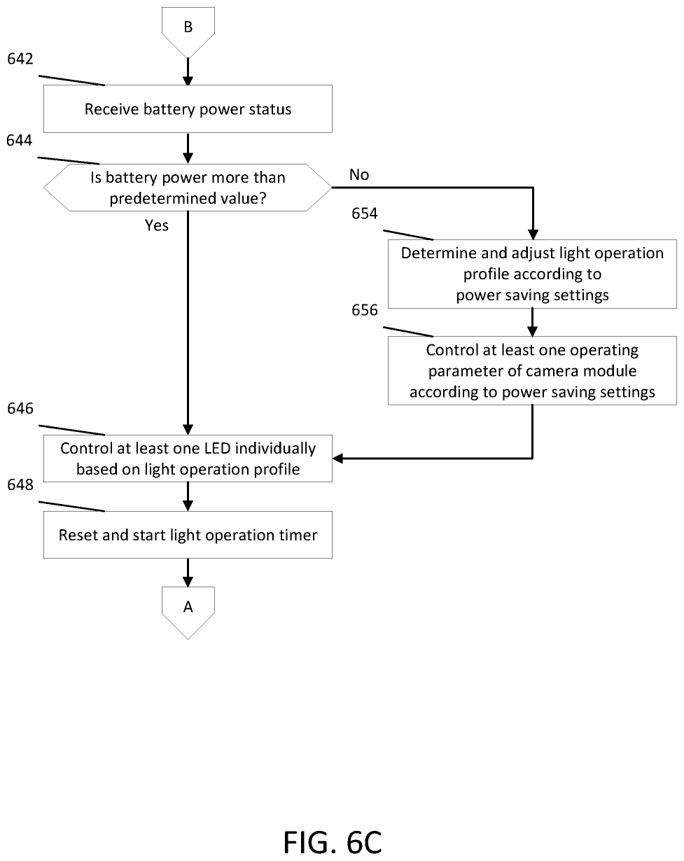

FIG. 6A-C collectively show a flow chart of an example method for using a motion-activated light 310. In step 602, a light operation profile may be initialized. The light operation profile may contain information indicating how the LED array 332 is to be controlled in different conditions (e.g., rules), and indicating a state of illumination for each LED in the LED array 332 (e.g., instructions). For example, the light operation profile may indicate how many LEDs are in the LED array 332, and how many positions (e.g., 525a-n as shown in FIG. 5B) are in the FOV of the motion-activated light 310. This may occur automatically, as the motion-activated light 310 may communicate with the LED array 332 during installation and/or receive information indicating the parameters of the LED array 332 (e.g., the number of LEDs, the types of LEDs, their brightness, their positioning, etc.). The information may also be configured manually by a user using, for example, the input device 308 and/or the mobile device(s) 125 that communicates with the motion-activated light 310.

The light operation profile may comprise information indicating how the motion event should be illuminated. For example, the light operation profile may indicate that positions (e.g., 525a-525n as shown in FIG. 5B) should be illuminated to encompass not only the subset of the positions 525a-525n in which motion was detected, but a surrounding area as well, to provide the fading effect discussed above. The light operation profile may comprise information indicating the degree to which light should illuminate detected motion (e.g., 50% illumination for the 1st range of the positions 525a-525n that surround the actual detected motion), and if desired, fade (e.g., 25% illumination for the 2nd range of the positions 525a-525n that surround the 1st range).

The light operation profile may indicate that different reactions are to occur for different types of detected motion. For example, the light operation profile may indicate that a smaller range is to be illuminated for recognized faces, while a larger range is to be illuminated for other types of moving objects (e.g., an animal, a car, etc.). The range (e.g., to be illuminated) may be measured or determined based on a subset of a plurality of positions (e.g., 525a-525n as shown in FIG. 5B) that indicates the motion detection and/or an image of the FOV captured by the camera module 340.

The light operation profile may indicate times of day for operation, and different operating parameters for different times of day. The light operation profile may indicate the ambient light threshold discussed above, and may be calibrated depending on the amount of illumination available from the LED array 332 and/or the image capture quality of the camera module 340.

In step 604, one or more parameters of a light reflection map may be established. The light reflection map may indicate lighting parameters that are due to objects with shiny surfaces in the FOV of the motion-activated light 310. Generation of the light reflection map is discussed further below, and in step 604, parameters for creating the light reflection map may be established. For example, the user may select a periodic schedule (e.g., weekly) for automatic generation/updating of the light reflection map.

In step 606, a measurement of ambient light may be obtained (e.g., from light sensor 324). In step 608, if the ambient light is brighter than a threshold (e.g., if it is daytime and no illumination is needed for the camera module 340), then the process may remain in step 606 until it is darker. Alternatively, if the ambient light is not brighter than the threshold, then the process may proceed to step 610.

In step 610, a determination may be made as to whether the light reflection map should be generated and/or updated. For example, if the user requests to generate and/or update the light reflection map (e.g., the user selects a corresponding option on a processor performing the process), the motion-activated light 310 may turn on some or all LEDs of the LED array 332 (step 612) and capture one or more images of reflection intensity of the light from the LED array 332 (step 614). The one or more captured images may be used to determine/calculate location(s) of the light reflection sources in the FOV of the motion-activated light 310 (step 618). For example, an image may be captured while the all LEDs of the LED array 332 are turned on. The power levels may be adjusted such that most areas in the FOV of the motion-activated light 310 are clearly visible. The motion-activated light 310 may determine location(s) that show an unwanted glare or bright spot (e.g., if brightness at the location(s) exceeds a glare threshold) in the captured image. Another example method of determining location(s) of light reflection sources may comprise turning on one LED of the LED array 332 individually at a time and capturing one or more images for the one LED of the LED array 332. By repeating for the all LEDs of the LED array 332, the motion-activated light 310 may scan and/or map out the location(s) of light reflection sources in the FOV of the motion-activated light 310 based on correlation between the operation of the LED of the LED array 332 (e.g., the driving power levels to the LED, the coordinate of the driven LED, the orientation angle of the driven LED, etc.) and the one or more images of reflection intensity of the light from each LED of the LED array 332. The light reflection map may be generated and/or updated based on the location(s) of the light reflection sources (step 620). The generating and/or updating may include establishing the light reflection map to indicate that, for the positions (e.g., 525a-525n as shown in FIG. 5B) that correspond to the glare or bright spot(s), the corresponding LED(s) should be kept off or used at a reduced intensity. Also or alternatively, these adjustments may be made to the light profile information.

In step 624, the motion-activated light 310 may determine detection of a motion event using the motion sensor 322. The motion sensor 322 may be capable of detecting the motion event and/or calculating a direction and/or a distance to the motion event from the motion sensor 322 (e.g., a radar with multiple receive antennas, a set of multiple passive infrared (PIR) sensors, etc.). If the motion event is detected (Yes in step 624), the motion-activated light 310 may receive the direction and/or the distance to the motion event from the motion sensor 322 (step 626). The light operation profile may be adjusted and/or updated based on the direction, the distance, and/or the light reflection map (step 628).

In step 644, battery power status associated with the motion-activated light 310 (e.g., received in step 642) may be compared to a threshold battery power value. If the battery power status is not more than the threshold battery power value (No in step 644), the motion-activated light 310 may determine and adjust the illumination state information in the light operation profile according to the power saving settings for the LED array 332 such as reducing a number of the LEDs used for illuminating the motion event, and/or reducing a power level and/or an illumination duration of the LEDs (e.g., pulsed light) (step 654). For example, the light operation profile may indicate that a smaller range is to be illuminated if the battery power is less than the threshold battery power value, while a larger range is to be illuminated if the battery power is more than the threshold battery power value. If multiple LEDs have overlapping regions, for example, then it may be desirable to determine such overlapping regions and reduce the number of illuminated LEDs for the overlapping regions.

In step 656, Settings for the camera module 340 may also be adjusted to conserve power, such as reducing a frame rate for image capture, and/or capturing fewer pixels such as binning the pixels of the image sensor to combine data from the nearby pixels into one, and/or reducing a capture area of the angle of view of the camera module 340 (e.g., to capture images of a subset area). For example, the camera module 340 may capture one or more images at a slower frame rate if the battery power is less than the threshold battery power value, while a faster frame rate is to be applied if the battery power is more than the threshold battery power value. The power saving setting for the LEDs (step 654) and/or the camera module (step 656) may be applicable if the battery power status is not more than the threshold battery power value. The process may proceed to step 646 to turn on the LED array 332 based on the adjusted/updated light operation profile. The adjusted/updated light operation profile may store information indicating a state of illumination for each LED in the LED array 332, and that the light operation profile may be adjusted/updated for a variety of reasons, as discussed above.

In step 648, a light operation timer may be reset and started. The light operation timer may be a software embedded in the motion-activated light 310 and configured to measure time. The measured time by the light operation timer may be used to keep the LED array 332 lighted on for a given amount of time, after the motion event is detected. For example, the light operation timer may be restarted each time motion is detected, and expiration of the timer may result in turning off the LED array 332 on the assumption that the motion event has passed. The process may then return to step 624.

If, in step 624, no motion is detected, then the process may proceed to step 632 and determine whether the light operation timer is running. If the light operation timer is running (Yes in step 632), then the motion-activated light 310 may keep the LED array 332 turned on and check detection of a motion event (step 624). Alternatively, if the light operation timer is not running in step 632 (e.g., the timer is expired), then the motion-activated light 310 may put the LED array 332 in a default condition (e.g., turn off all the LEDs, turn on the at least one LED at a lower power level, etc.) (step 638). The process may proceed to step 606 (e.g., receiving measurement of ambient light) and determine whether the ambient light is darker than the threshold brightness (step 608).

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

1. A method comprising:
receiving, by a computing device, a motion detection signal related to a field of view (FOV) of a camera, wherein the motion detection signal comprises information identifying a position within the FOV;
associating the identified position within the FOV with one or more light sources, of a plurality of light sources, of the camera; and
controlling the one or more light sources to illuminate the position within the FOV.

2. The method of claim 1, wherein the controlling comprises adjusting different light sources of the one or more light sources with different intensities.

3. The method of claim 1, wherein the controlling comprises:
turning on a first subset of the one or more light sources at a first intensity to illuminate focusing on the position within the FOV; and
turning on a second subset of the one or more light sources, surrounding the first subset of the one or more light sources, at a second intensity that is lower than the first intensity.

4. The method of claim 1, wherein the plurality of light sources are co-located with a motion sensor capturing the motion detection signal.

5. The method of claim 1, wherein the controlling comprises adjusting different light sources of the one or more light sources to illuminate with different intensities based on a distance to the position within the FOV.

6. The method of claim 1, wherein the controlling comprises determining intensity of the one or more light sources based on a battery level associated with the computing device.

7. The method of claim 1, further comprising determining the one or more light sources based on a battery level associated with the computing device.

8. The method of claim 1, further comprising:
generating a light reflection map based on glare detected in a calibration image of the FOV; and
determining a subset of the one or more light sources that should be reduced based on one or more locations, corresponding to the glare, in the light reflection map.

9. The method of claim 1, further comprising:
receiving, by the computing device, a camera image of the FOV illuminated by the one or more light sources; and
based on determining a region of interest (ROI) in the camera image, adjusting different light sources of the one or more light sources with different intensities to illuminate focusing on the ROI.

10. A method comprising:
receiving, by a computing device, a motion detection signal related to a field of view (FOV) of a camera, wherein the motion detection signal comprises information identifying a position within the FOV;
receiving information indicating a battery level associated with the computing device;
selecting, based on the battery level and on the position within the FOV, one or more light sources, of a plurality of light sources, of the camera; and
controlling the one or more light sources to illuminate the position within the FOV.

11. The method of claim 10, wherein the controlling comprises determining intensity of the one or more light sources based on the battery level.

12. The method of claim 10, further comprising receiving, by the computing device, one or more camera images of an area limited to a portion of the FOV that is illuminated by the one or more light sources.

13. The method of claim 10, further comprising determining a camera frame rate based on the battery level.

14. A method comprising:
activating one or more light sources of a plurality of light sources of a camera device;
receiving, by the camera device, a camera image of a field of view (FOV) of the camera device illuminated by the one or more light sources;
generating a reflection map indicating one or more positions, in the camera image, comprising glare;
receiving, by the camera device, a motion detection signal related to the FOV, wherein the motion detection signal comprises information identifying a position within the FOV;
selecting, based on the reflection map and on the position within the FOV, a subset of the plurality of light sources; and
controlling the selected subset, of the plurality of light sources, to illuminate the position within the FOV.

15. The method of claim 14, wherein the controlling comprises determining one or more light sources of the subset of the light sources that should be reduced based on the reflection map.

16. The method of claim 14, wherein the controlling comprises adjusting different light sources of the subset of the light sources with different intensities.

17. The method of claim 14, wherein the controlling comprises:
turning on a first plurality of light sources of the subset of the light sources at a first intensity to illuminate focusing on the position within the FOV; and
turning on a second plurality of light sources of the subset of the light sources, surrounding the first plurality of light sources, at a second intensity that is lower than the first intensity.

18. The method of claim 14, wherein the controlling comprises adjusting different light sources of the subset of the light sources to illuminate with different intensities based on a distance to the position within the FOV.

19. The method of claim 14. wherein the controlling comprises determining intensity of the subset of the light sources based on a battery level associated with the camera device.

20. The method of claim 14. further comprising determining the subset of the light sources based on a battery level associated with the camera device.
